(19) United States
(12) Patent Application Publication
(10) Pub. No.: US 2022/0221944 A1
(43) Pub. Date: Jul. 14, 2022

(54) SYSTEM AND METHOD OF AN AMBIDEXTROUS MULTI-PURPOSE SHOOTERS REMOTE DEVICE

(71) Applicant: Jagrut Patel, Weston, FL (US)

(72) Inventors: Jagrut Patel, Weston, FL (US); Sumeet Suri, Weston, FL (US); Charles Ferrera, Ft. Lauderdale, FL (US); Daniel Berube, Amherst, NH (US); James Baker, Seabrook, NH (US)

(21) Appl. No.: 17/144,564

(22) Filed: Jan. 8, 2021

(51) Int. Cl. G06F 3/023; F41G 1/38; F41A 35/06; G06F 3/02

(52) U.S. Cl. CPC G06F 3/0238; G06F 3/0202; F41A 35/06; F41G 1/38

(57) ABSTRACT

A firearm-mounted system for remotely controlling firearm components and user body-attached systems is provided. The system comprises a manually activated remote-control device mounted to a side area of a firearm rail that when activated receives at least a first manual entry into a keypad of the remote-control device. The system also transmits instructions associated with the entry to an optical device attached to the firearm, the instructions causing the optical device to display at least one configuration optic. The system also receives at least a second manual entry into the keypad, instructions generated by the entry causing selection of the least one configuration optic, the selection thereafter executed by the optical device. The device mounts to a right side of the rail for left-handed users and to a left side of the rail for right-handed users. The device communicates wirelessly and/or via wired connection with the optical device.

### FIELD OF THE INVENTION

The present disclosure is in the field of combat and hunting firearms. More particularly, the present disclosure provides a system for remotely controlling weapons mounted electro optics and other devices combined with soldier body- and uniform mounted devices via a fingertip-manipulated keypad mounted to a weapon system rail or person in support of I.S.W. (Intra Solider Wireless)

### BACKGROUND

Soldiers and other users of weapon systems seek to limit physical movement when aiming at a target. A sniper or other marksman aiming a weapon system may need to make configuration choices and adjustments to optical devices on the weapon or other related ISW capable device(s)

The soldier may need to control such devices attached to his/her body weapon system, uniform or person during a combat situation. A soldier affixing aim on a target may want to adjust his/her weapon's optics or body-attached device while limiting the movement his/her hands to make those adjustments thus, remaining very still on target. Evading detection and successfully engaging a target(s) may be a life-or-death risk for a soldier in combat or other related activities and the shooters remote will improve the soldier/operators capabilities during these types of situations or engagements.

### BRIEF DESCRIPTION OF THE FIGURES

FIG. 1 through FIG. 26 are diagrams of an ambidextrous multi-purpose shooter's remote device in accordance with an embodiment of the present disclosure.

### DETAILED DESCRIPTION

Systems and methods described herein provide a remote-control device with keypad for controlling optical and other devices on a weapon system. The remote-control device is mounted on either a left or right side of the weapon system affixed to a handguard, rail or other mechanical component to support left-handed or right-handed shooters, thus providing fully ambidextrous capability.

The keypad is used by the operator to enter commands via fingertip manipulation of the keys. The entered commands are sent by the remote-control device either wirelessly or via wired connection to optical devices and or peripherals. In an example, a thermal optic is mounted on the weapon system and operator therefore does not need to remove his/her hands from the weapon system to configure and manipulate the optic or other peripheral attached device(s). Using only finger movements, the user enters commands while continuing to maintain his/her body and the weapon system steady, a critical requirement in most combat situations.

The remote-control device contains functionality to configure and control body-mounted devices in addition to weapons-mounted devices. As with optics and other weapon-mounted devices, the remote-control device may provide such control wirelessly or via wired connection. The ability to control such body-mounted devices may also be critical in combat operations.

The remote-control device attaches to a left-hand side of the weapon (from the user's perspective while holding the firearm) for right-handed shooters. Conversely, the remote-control device attaches to the right-hand side of the weapon for left-handed shooters.

A right-handed shooter will have his/her primary fire control finger on the trigger and will support the weapon with his/her support hand. The desired fingers of his/her left hand will be on the keypad of the remote-control device that is mounted on the left side of the weapon system. He/she will be able to manually enter commands with his/her desired fingers into the keypad while only minimally moving the weapon. For example, as a sniper or marksman, he/she will be able to silently and almost motionlessly enter commands that change aspects of the optics or peripherals and thereby be better able to improve aim at an enemy combatant or desired target in addition to limiting one's movements and improving stealth in the field.

A left-handed shooter will conversely have his/her left index designated finger on the fire controls and will support the weapon system using his/her support hand. The desired fingers of his/her right hand will be on the keypad of the remote-control device that is mounted on the right side of the weapon system. Only minimal movements of the weapon or body may be necessary.

The remote-control device auto detects the keypad for right-handed or left-handed shooters when wired or is programmable for wireless operations. The remote-control device can detect if it has been moved from one side of the weapon to the other, thus necessitating such auto reprogramming of keypad.

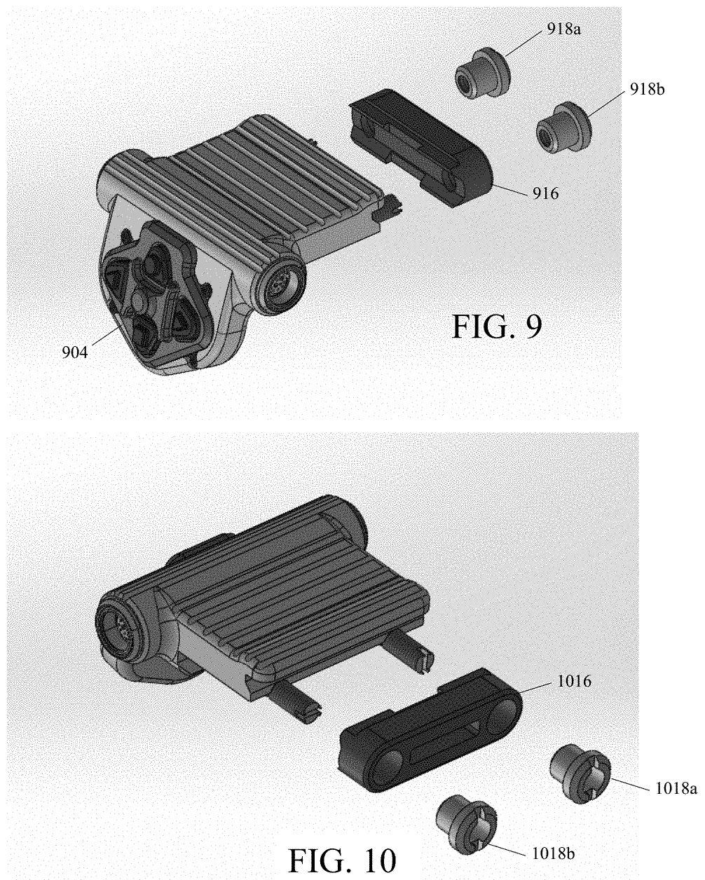

The remote-control device has two connectors located near its top off axis line, one each at the upper ends of the remote-control device in-line. The connectors are illustrated in FIG. 9 and FIG. 10. One connector faces toward the shooter and the other connector faces away from the shooter. Depending on which side of the weapon that the remote-control device is attached, one or the other connector will be pointing toward and near the optical device or operators' workspace.

In many embodiments a cable extends from the optical device forward toward the far end of the weapon or in a desired space and hence the remote-control device. The cable plugs into the proximate connector on the remote-control device (the connector pointing to the optical device and not away from the optical device) so the remote-control device can send commands via the cable to the optical device when utilizing a cable connection. The remote-control device detects which of its two connectors has physically received the cable. Based on the detection, the remote-control device determines whether the shooter is right-handed or left-handed and programs the keypad accordingly while the other connector is capable of connection to other devices such as remote power to extended optical support runtime. The wireless variant, a series of buttons are depressed to program the remote for right-handed or left-handed operations.

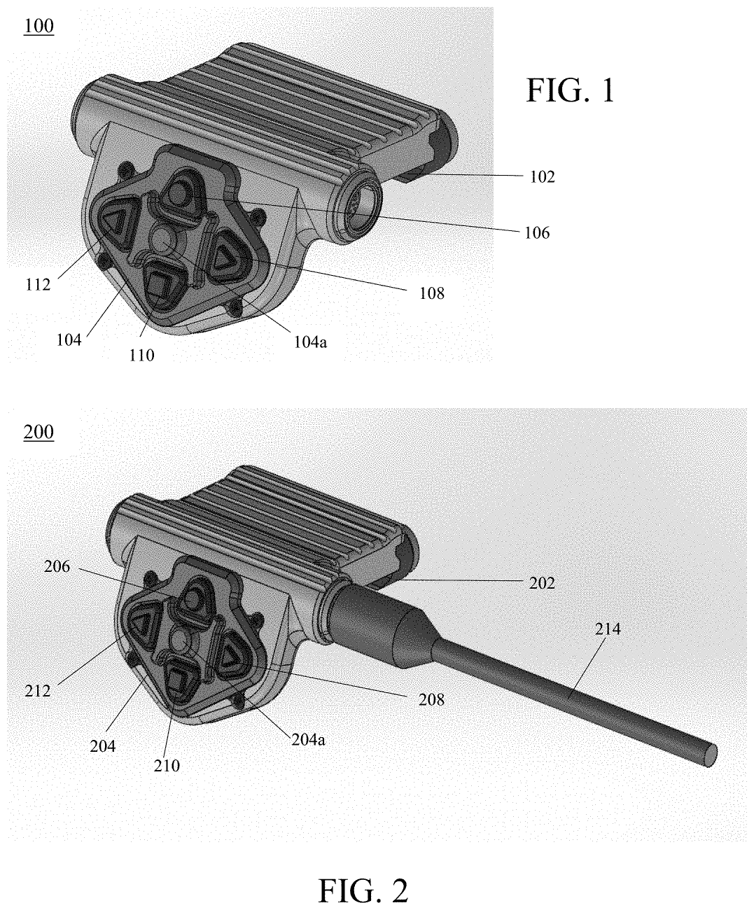

Turning to the figures, FIG. 1 is a close-up image of the remote-control device, presented as a system 100. FIG. 1 depicts a base 102 that can be attached to any 1913 Picatinny Rail via a standard rail, MLOK or KeyMod mechanical attachment device. In the case of at least a MIL-STD-1913 Picatinny weapon rail, a well-known and popular rail, the remote-control device may be secured to the rail attachment via plate and locking nuts or quick-detachable mechanism which is self-adjusting to the rail attachment point

FIG. 1 also depicts a keypad 104 and a quantity four keys 106, 108, 110, 112 for user fingertip placement. The remote-control device also includes a cable that attaches to an optical device or power accessories as discussed above. The cable may plug into one or the other connector on the remote-control device. The connectors are not shown in FIG. 1. Subsequently, all keys or buttons are customizable to the end-user specific requirements and can be configured as such when requested. The below outlines the standard configuration of button methodology for both right-handed and left-handed operations on a weapon system.

Key 106 may allow for “EZOOM/LASER ACTIVATION or LRF.” Key 108 may represent “back/down menu or polarity hot-key.” Key 110 may represent “MENU/POWER/ENETER or SELECT.” Key 112 may represent “forward/up menu.” Key 104a which is at the center of the keypad 104 is a customizable button for end user requirements that have specific needs for an additional button.

Components in FIG. 2 through FIG. 9 are indexed to components provided by the system 100 and depicted in FIG. 1. FIG. 2 is another view of the remote-control device, provided and depicted as a system 200. FIG. 2 provides a view of the remote-control device similar to the view provided by FIG. 1 but with the cable described above enumerated in FIG. 2 cable 214.

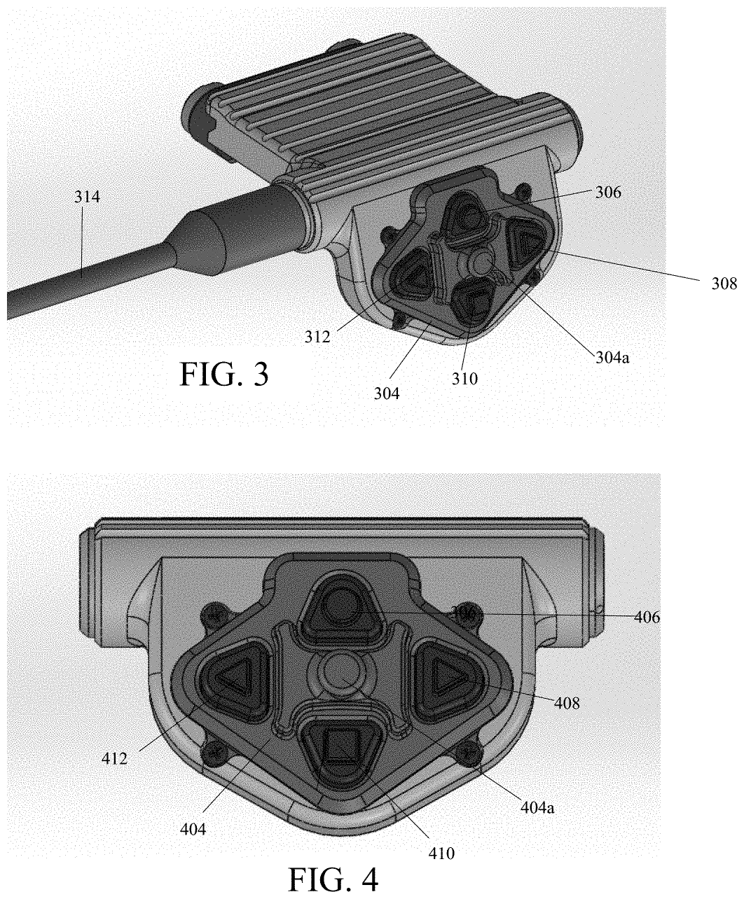

FIG. 3 is the same view of the remote-control device as in FIG. 2 but with the cable 314 inserted into the other side of the device. Embedded in the housing on the top side of the device is a compartment for battery power CR2023 that will provide power to the unit for wireless variants.

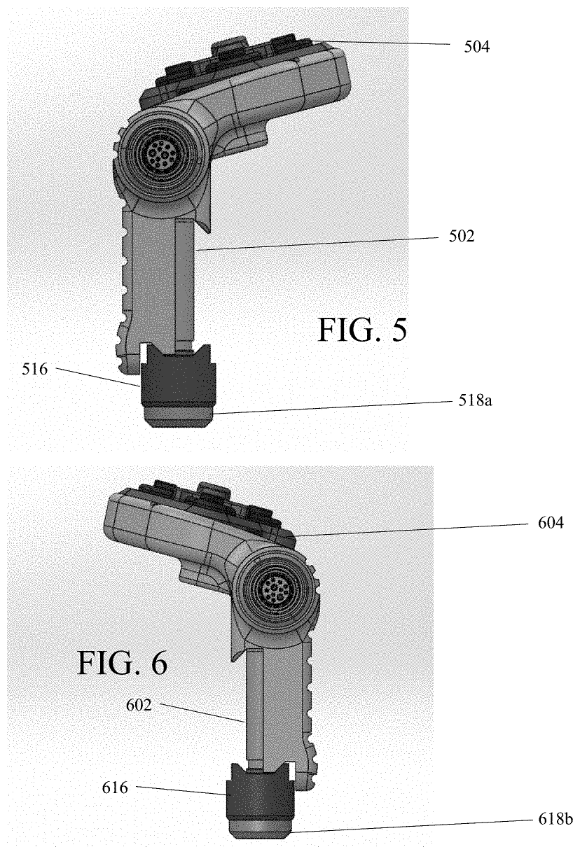

FIG. 4 is a front view of the remote-control device and FIG. 5 is a side view of the device with attachment plate 516 and nut 518a shown. FIG. 6 is a view of an opposite side of the device with attachment plate 616 and nut 618b shown.

FIG. 5 and FIG. 6 depict the base 502 and 602, respectively, that would set upon the top of the 1913 rail or other mounting solution as described above.

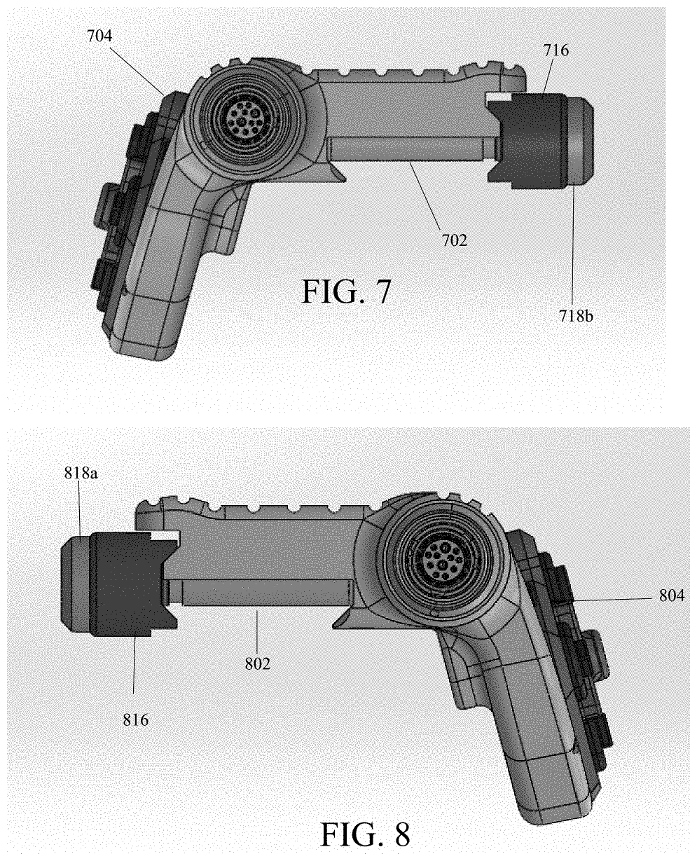

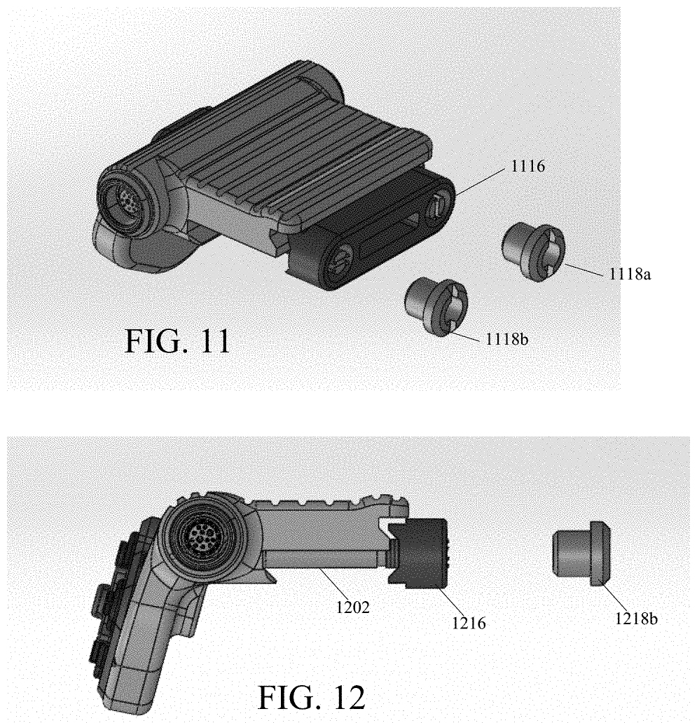

Similar to FIG. 5 and FIG. 6, FIG. 7 and FIG. 8 are views of the remote-control device from opposite sides. FIG. 7 includes the nut 718b and FIG. 8 includes the nut 818a. FIG. 9, FIG. 10, and FIG. 11 are three similar views of the device with attachment plates 916, 1016, 1116 and nuts 918a-b, 1018a-b, 1116a-b depicted, respectively.

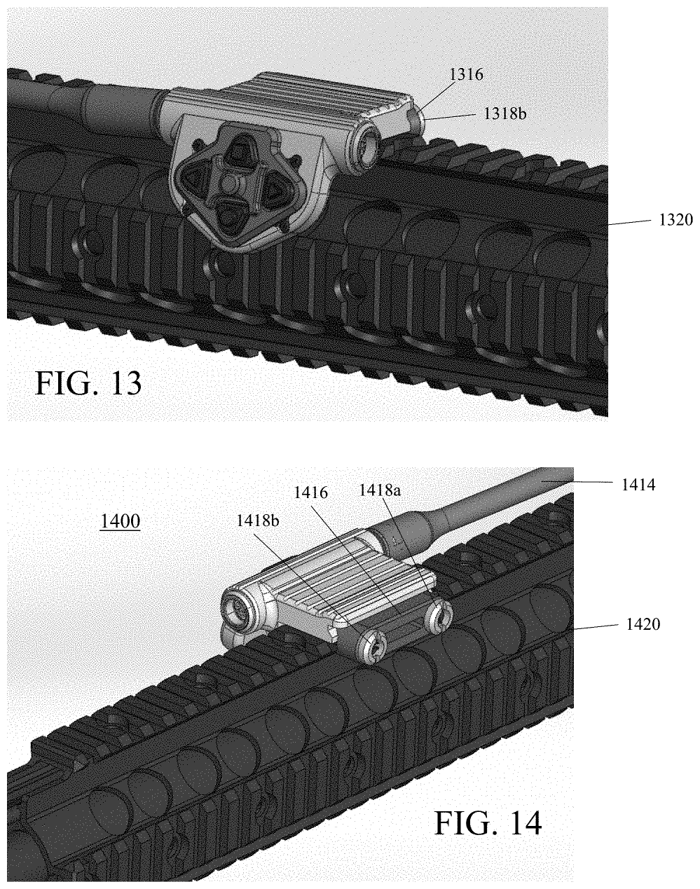

FIG. 12 is a side view of the device with attachment plate 1216 and nut 1218b. FIG. 13 is a view of the device 1300 atop a rail 1320 as described above. The device attaches to the rail via the attachment plate 1316 as described.

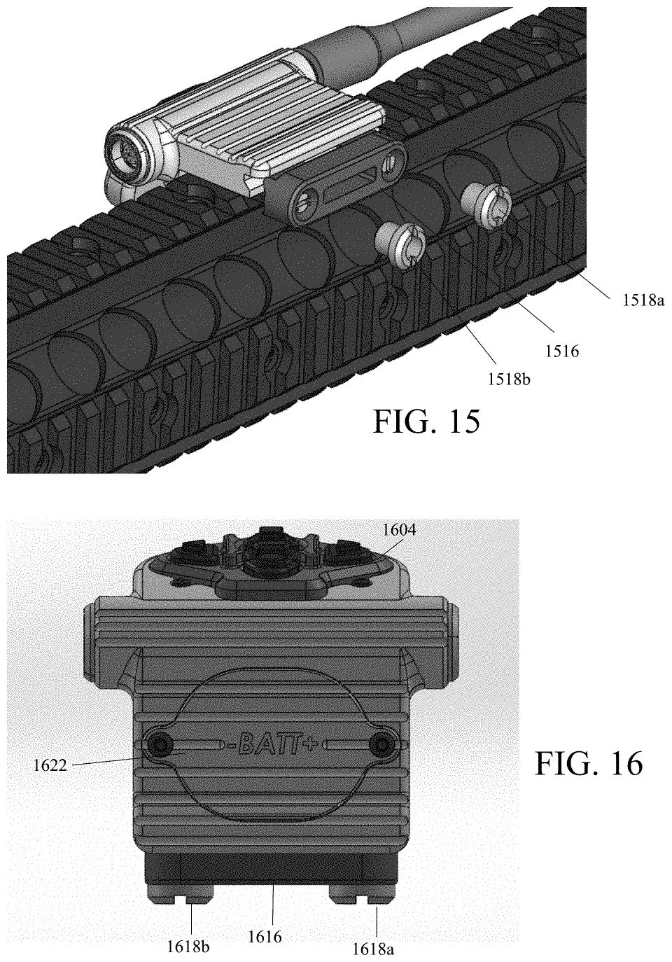

FIG. 14 and FIG. 15 provide identical views of the components provided herein with the nuts 1418a-b shown as fully inserted in FIG. 14. The nuts 1518a-b are shown away from the attachment plate 1516 in FIG. 15 in an exploded view of the components.

FIG. 16 shows the remote-control device with an attached battery cover 1622 fastened to a top surface of the device. The cover is atop a compartment for battery power CR2023 that provides power to the unit for wireless variants.

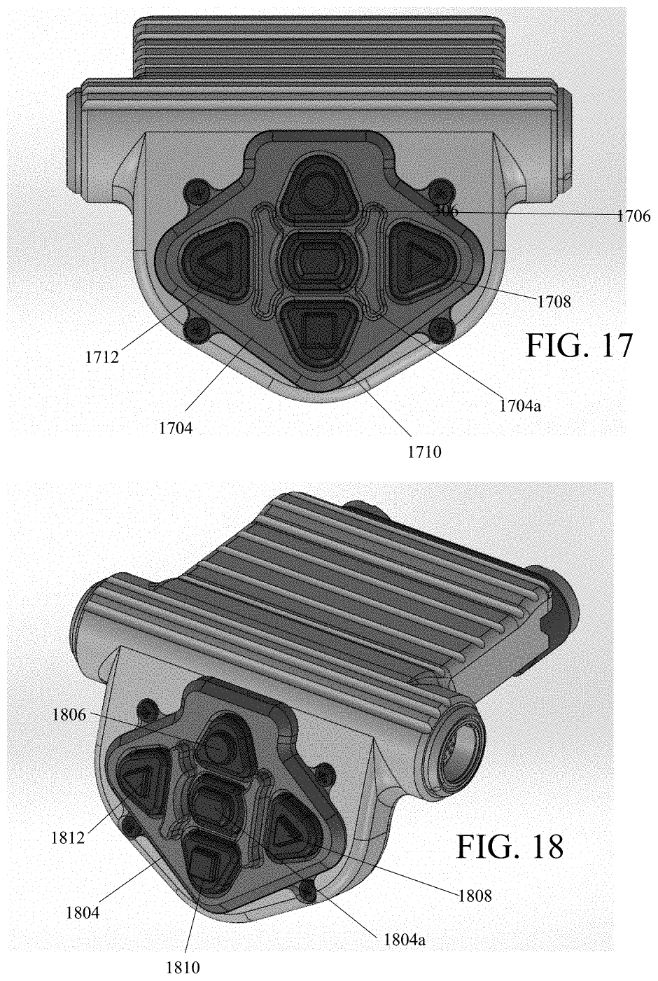

FIG. 17 depicts the selectable buttons on the face of the keypad 1704. These include the optional fifth button 1704a in the middle of the other buttons. In embodiments, the fifth button 1704a is provided for users to access some peripheral features such as “Dedicated LRF” so that button 1704a would discharge or activate said features.

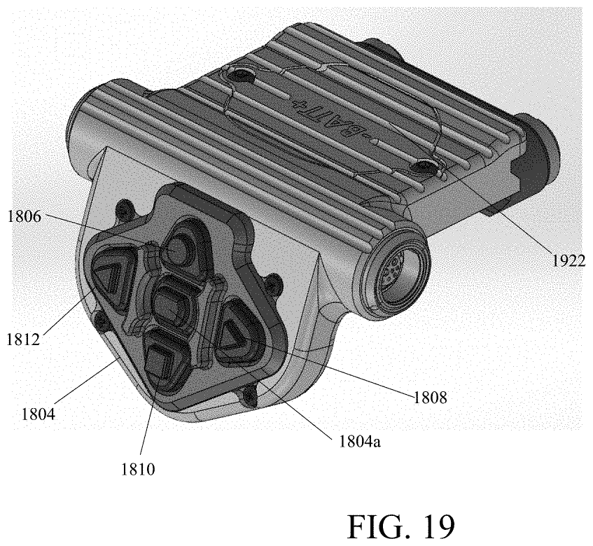

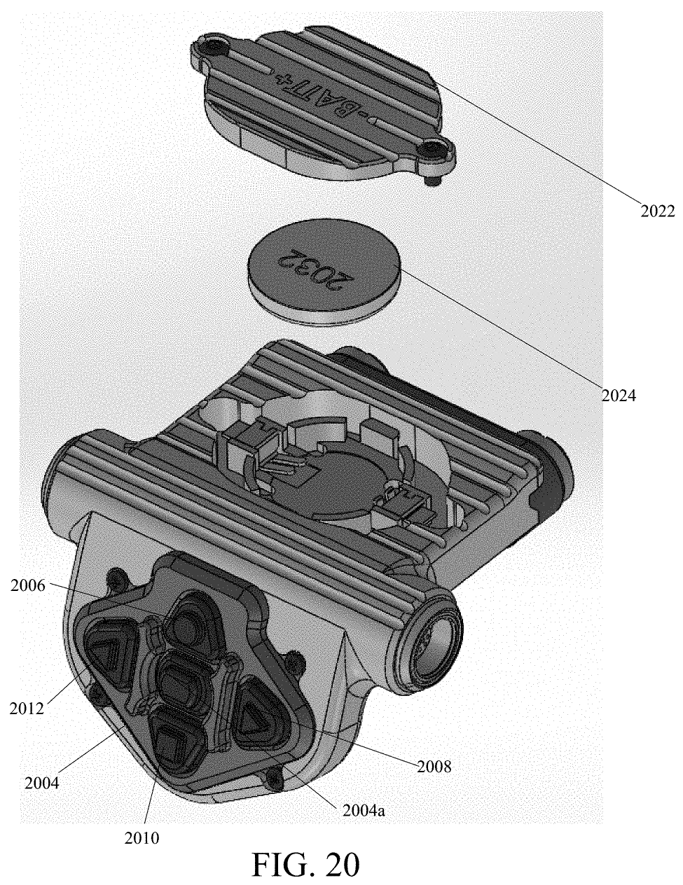

FIG. 18 and FIG. 19 provide the same view of the device with battery cover 1922 shown in FIG. 19 and the corresponding component not shown in FIG. 18. FIG. 20 shows some components of the device in exploded view including battery cover 2022 and battery 2024.

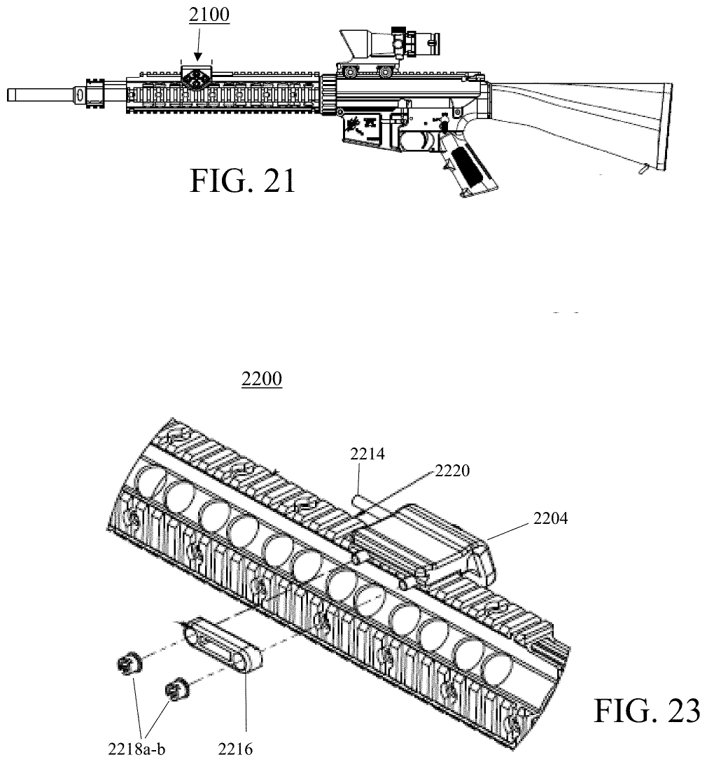

FIG. 21 is a view of a firearm that hosts the remote-control device, labeled as component 2100 in FIG. 21. FIG. 22 is a close-up view of a system 2200 of the remote-control device and particularly depicted how the remote-control device attaches to the firearm.

While not part of the remote-control device and not an essential aspect of systems and methods provided herein, the rail 2200 is labeled and shown for discussion purposes. The attachment plate 2216 and the nuts 2218a-b are shown in the manner in which they align for installation on the rail 2220. Additionally, with MLOK or KeyMod attachment mechanisms, the device will also connect to any of those configurations using the same locking system or quick disconnect option.

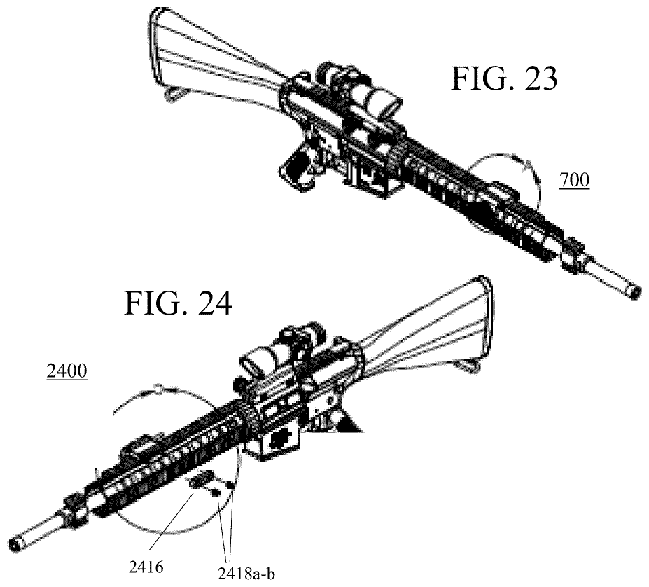

FIG. 23 is similar to FIG. 21 in providing a view of a weapon that hosts the remote-control device, labeled as component 2300 in FIG. 7. FIG. 24 is similar to FIG. 23 but depicts attachment of the remote-control device to the firearm with attachment plate 2416 and nuts 2418a-b shown.

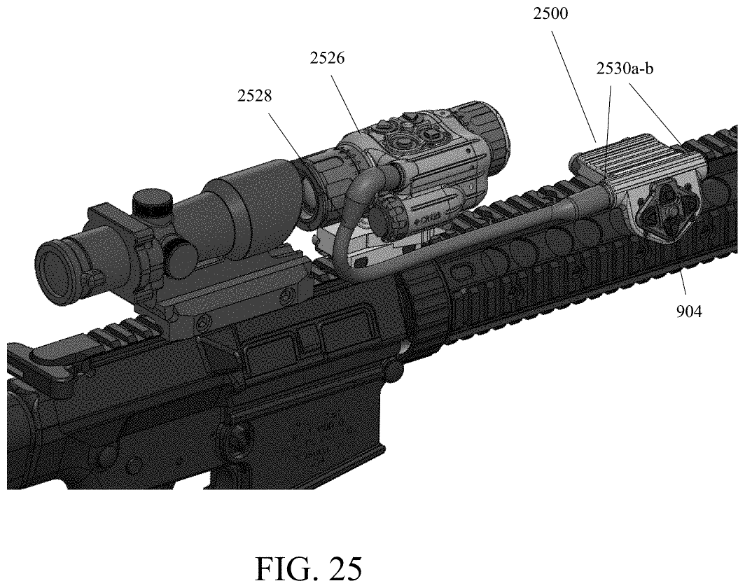

FIG. 25 illustrates the use of the connectors discussed above and how an optical device connects to the remote-control device provided herein. FIG. 25 depicts an electro-optical device 2526 that can be plugged in either end of the remote-control device 2500 via a cable 2528 discussed above. The remote-control device has logic to determine which end (2530a or 2530b) of the remote-control device has received the cable 2528. The remote-control device, based on which end 2530a or 2530b is plugged-into, determines if the shooter is right-handed or left-handed. The remote-control device further automatically re-purposes the keys of the keypad 904 to match the right/left hand shooter. In the example depicted by FIG. 25, the configuration shown is for a left-handed shooter.

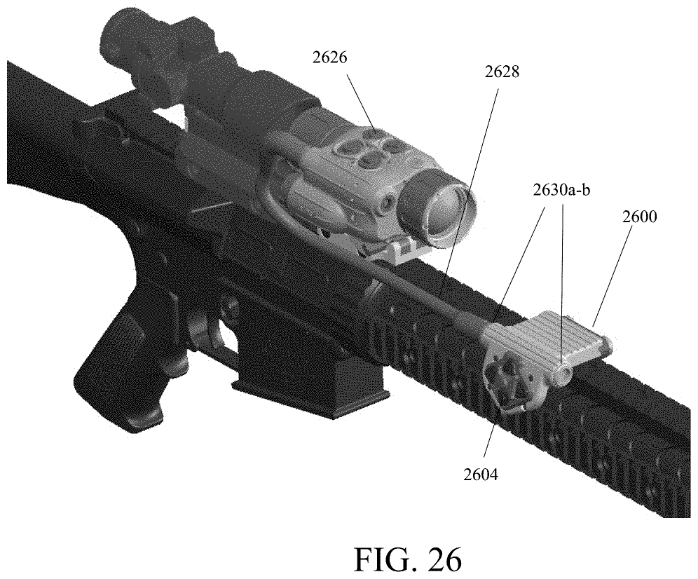

FIG. 26 depicts the same configuration shown in FIG. 25 but from a different angle. FIG. 26 depicts the electro-optical device 2626 that can be plugged in either end of the remote-control device 2600 via a cable 2628 discussed above. The remote-control device 2600 has logic to determine which end (2630a or 2630b) of the remote-control device has received the cable 2628. The remote-control device 2600, based on which end 2630a or 2630b has received insertion of the cable 2628, determines if the shooter is right-handed or left-handed.

The remote-control device has wireless capability comprising both Bluetooth and Intra Soldier Wireless (ISW) Radio. When wireless, the remote-control device can transmit both custom as well as standards compliant messages (messages formatted for universal remote control in military domain).

The remote-control device can also be used as a wireless gateway from firearm-mounted electro optical devices to many Bluetooth or ISW enabled Peripherals (depending on the firmware loaded on the remote). The remote-control device over Bluetooth and/or ISW can control many body area systems on the modern warfighter, for example IVAS (Integrated Visual Augmentation System), GPS, ATAK (Android Tactical Awareness Kit), and Radio. As noted, depending on the orientation (left- or right-handed hand shooter, the keys on the remote are on demand re-purposed (the forward key becomes the back key and so forth).

The remote-control device can be mounted on a Picatinny Rail (MIL-STD-1913 Rail), MLOK Handguard OR KEYMOD Handguard System.

The new generation Fire Control Scopes are mounted on the weapon system and may be controlled by systems and methods provided herein. The scopes include Laser Range Finders, for example Wilcox Raptor-S or equivalent system. Lasers are also controllable by the remote-control device, for example Steiner/Laser Devices DBAL-RL Laser Aiming System or equivalent. Also, the wireless transmission enables two-way exchange with sensors and devices on the soldier's body or uniform. Such body- or uniform-attached devices that may be controllable by the remote-control device may include Night Vision Goggles, GPS receivers, and Gunshot Detection Systems.

What is claimed is:

1. A firearm-mounted system for remotely controlling firearm components and user body-attached systems, comprising:
a manually activated remote-control device mounted to a side area of a firearm rail that when activated:
receives at least a first manual entry into a keypad of the remote-control device,
transmits instructions associated with the entry to an optical device attached to the firearm, the instructions causing the optical device to display at least one configuration optic,
receives at least a second manual entry into the keypad, instructions generated by the entry causing selection of the at least one configuration optic, the selection thereafter executed by the optical device.

2. The system of claim 1, wherein the remote-control device mounts to one of a left side and a right side of the rail.

3. The system of claim 2, wherein the remote-control device mounts to the right side for left-handed users and mounts to the left side for right-handed users.

4. The system of claim 1, wherein the remote-control device communicates at least one of wirelessly and via wired connection with the optical device.

5. The system of claim 1, wherein the remote-control device further communicates with additional devices attached to a user of the firearm.

6. The system of claim 5, wherein the additional devices are attached to a uniform of an operator for use with or without a weapon system.

7. The system of claim 6, wherein the additional devices comprise at least one of IVAS (Integrated Visual Augmentation System), GPS, ATAK (Android Tactical Awareness Kit), and radio.

8. The system of claim 1, wherein the remote-control device reprograms the keypad based on detection of one of right-hand user and left-hand user when using a cable or programable configuration buttons for a wireless variant.

9. A system for remotely controlling weapons-mounted and body-mounted electronic devices, comprising:
a remote-control device mounted on one of a first side and a second side of a rail of a weapon system;
a keypad on a face of the remote-control device;
a first connector above the face on a first end of the device;
a second connector above the face on a second end of the device, the second end opposite the first end; and
an application executing on device that:
detects presence of a cable plugged into the first connector,
determines that an opposite end of the cable is plugged into an optical device mounted on the firearm,
determines, based on the detection, that the device is physically positioned on the first side of the firearm, the physical positioning accommodating one of a left-handed user and a right-handed user, and
based on reading of a stored configuration, one of reprograms the keypad and verifies existing programming of the keypad.

10. The system of claim 9, wherein the application reprograms the keypad upon determining that the stored configuration is incorrect for the first side of the weapon

11. The system of claim 10, wherein the determination indicates that the physical positioning of the remote-control device has changed since an immediately previous use of the optical device.

12. The method of claim 9, wherein the application verifies existing programming of the keypad upon determining that the stored configuration is correct for the first side of the weapon.

13. The system of claim 12, wherein the determination indicates that the physical positioning of the remote-control device has not changed since an immediately previous use of the optical device.

14. The system of claim 9, wherein the keypad receives manual commands by the user to at least one of configure attached devices and cause execution of actions by the attached devices.

15. The system of claim 9, wherein the remote-control device additionally sends commands one of wirelessly and via wired connection to devices attached to a uniform of an operator using the weapon system or on a person.

16. A method for remotely controlling firearm components and user body-attached systems, comprising:
a manually activated remote-control device mounted to a side area of a weapon rail receiving at least a first manual entry into a keypad of the remote-control device,
the remote-control device transmitting instructions associated with the entry to an optical device attached to the firearm, the instructions causing the optical device to display at least one configuration optic, and
the remote-control device receiving at least a second manual entry into the keypad, instructions generated by the second manual entry causing selection of the at least one configuration optic, the selection thereafter executed by the optical device.

17. The method of claim 16, further comprising the remote-control device mounting to one of a left side and a right side of the rail.

18. The method of claim 17, further comprising the remote-control device mounting to the left side for right-handed users and mounts to the right side for left-handed users.

19. The method of claim 16, further comprising the remote-control device communicating at least one of wirelessly and via wired connection with the optical device.

20. The method of claim 16, wherein the remote-control device reprograms the keypad based on detection of one of right-hand user and left-hand user or wireless variant that is programmable for either right or left-handed operation.
